(19) United States
(12) Patent Application Publication
(10) Pub. No.: US 2025/0255275 A1
(43) Pub. Date: Aug. 14, 2025

(54) Pet Toy

(71) Applicant: Christina Shannon Pegg, Winnetka, IL (US)

(72) Inventor: Christina Shannon Pegg, Winnetka, IL (US)

(21) Appl. No.: 18/383,474

(22) Filed: Feb. 8, 2024

(51) Int. Cl. A01K 15/02

(52) U.S. Cl. CPC A01K 15/026

(57) ABSTRACT

In some aspects, a pet toy includes a first substrate folded to dispose a first lateral edge adjacent a second lateral edge opposite to the first lateral edge to define a seam between the first lateral edge and the second lateral edge and a plurality of stitches, spaced apart along the seam in an interrupted pattern, to join the first lateral edge and the second lateral edge.

### BACKGROUND

Intestinal foreign bodies, and particularly linear foreign bodies (e.g., string, dental floss, fishing line, Christmas tinsel, Easter grass, ribbon, thread, etc.), have the potential to lead to life-threatening conditions when ingested by animals, such as kittens, puppies, cats or dogs. Cat tongues, in particular, are covered in small spines or papillae comprising sharp, backward-facing (angled toward the back of the tongue) hooks. Due to the papillae, it can be difficult for a cat to dislodge a linear foreign body (e.g., a thread) from the cat's tongue and the structure of the papillae can cause the cat's efforts to dislodge the linear foreign body to actually continue to work its way toward the back of the cat's tongue where it is then inadvertently swallowed. In some instances, as a cat swallows the thread, it may become wrapped around the base of the cat's tongue or anchored/lodged in the stomach or elsewhere in the gastrointestinal tract, such as the intestine, with the free end of the thread trailing down the remainder of the gastrointestinal tract. Traction on the anchor point can lead to adverse outcomes such as intestinal tear or perforation caused by a repeated sawing motion of the thread along the intestinal wall with resulting leakage of the intestinal contents into the abdomen, sepsis or peritonitis, which is life-threatening. In other instances, a linear foreign body can lead to gastrointestinal obstruction or blockage of the intestines, such as could be caused by movement of the intestines themselves responsive to the linear foreign body.

### BRIEF DESCRIPTION OF THE DRAWINGS

FIG. 1 is an image of an example pet toy in accord with at least some aspects of this disclosure.

FIG. 2 is an image of another example pet toy in accord with at least some aspects of this disclosure being played with by a cat.

FIG. 3 is a drawing of a portion of an example pet toy in accord with at least some aspects of this disclosure depicting a first example stitching.

FIG. 4 is a drawing of a portion of an example pet toy in accord with at least some aspects of this disclosure depicting a second example stitching.

FIG. 5 is a drawing of a portion of an example pet toy in accord with at least some aspects of this disclosure depicting a third example stitching.

FIG. 6 is a line drawing representing the image of the example pet toy of FIG. 1.

The drawings are not to scale. Wherever possible, the same reference numbers will be used throughout the drawing(s) and accompanying written description to refer to the same or like parts. As used in this patent, stating that any part is in any way positioned on (e.g., positioned on, located on, disposed on, etc.) another part, indicates that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

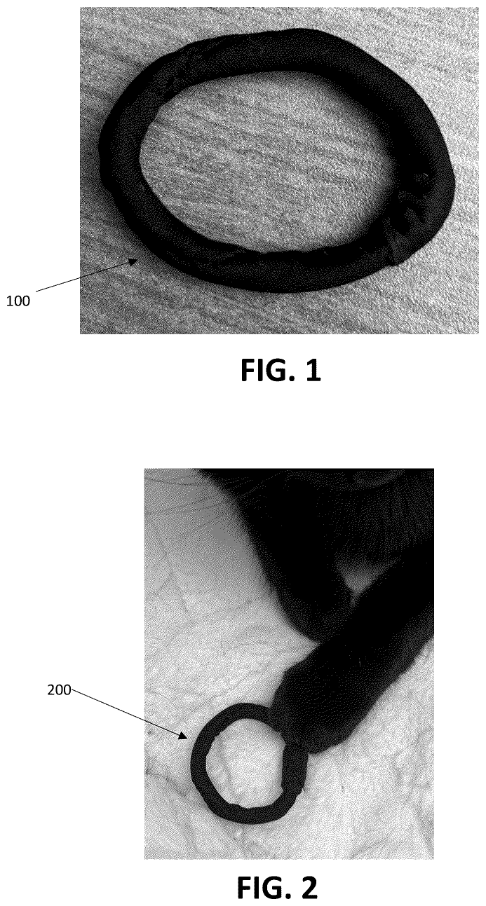

FIG. 1 is an image of an example pet toy 100 in accord with at least some aspects of this disclosure having a generally annular or ring-like shape, akin to a hair tie or a scrunchie for, example, and FIG. 2 is an image of another example pet toy 200, also having a generally annular or ring-like shape, in accord with at least some aspects of this disclosure being played with by a cat. In other aspects, the example pet toy 100, 200 may comprise other shapes and forms such as, but not limited to an oval or elliptical shape, a polygonal shape, or a polyhedral/polyhedron shape (e.g., a spherical polyhedron, deltahedron, icosahedron, etc.).

In at least some aspects, the material used to construct the example pet toy 100, 200 comprises an elastomeric substrate (e.g., a “first substrate”) of a synthetic rubber, such as polychloroprene or Neoprene, the substrate having the form or a ribbon or layer with a thickness between about 1-7 mm and, in some embodiments, a thickness of 1 mm or a thickness between about 1-3 mm. In some aspects, the first substrate could comprise a plurality of separate layers of an elastomeric substrate comprising one material, or a plurality of different elastomeric materials. Significantly, particularly as to cats, the elastomeric substrate does not fray when cut and presents no fibers able to be ensnared on the cat's papillae.

In at least some aspects, the substrate of the synthetic rubber is integrated with one or more or other substrate(s), such as by chemical bonding (e.g., an adhesive, etc.), thermal bonding, or the like, or a coating or forming process, the one or more or other substrate(s) comprising, for example, a natural or a synthetic fabric (e.g., a polyester fabric, a nylon fabric, a linen fabric, a cotton fabric, a silk fabric, Spandex, etc.) or material. In some examples, the example pet toy 100, 200 comprises only a substrate of an elastomeric material. In some examples, the example pet toy 100, 200 comprises a first substrate of an elastomeric material and a second substrate formed on or attached to a first side of the first substrate. In some examples, the example pet toy 100, 200 comprises a first substrate of an elastomeric material, a second substrate formed on or attached to a first side of the first substrate, and a third substrate formed on or attached to a second side of the first substrate opposite to the first side. In some examples, the second substrate and the third substrate are the same material and, in other aspects, the second substrate and the third substrate comprise different materials.

In some examples, where the form factor of the pet toy 100, 200 is that of a generally annular or ring-like shape, such as is shown by way of example in FIGS. 1-2, the second substrate and/or the third substrate have a thickness between about 0.1 mm to about 0.4 mm (e.g., between 0.15-0.25 mm). In some examples, the second substrate and/or the third substrate could, in turn comprise a plurality of layers of one or more natural and/or synthetic materials.

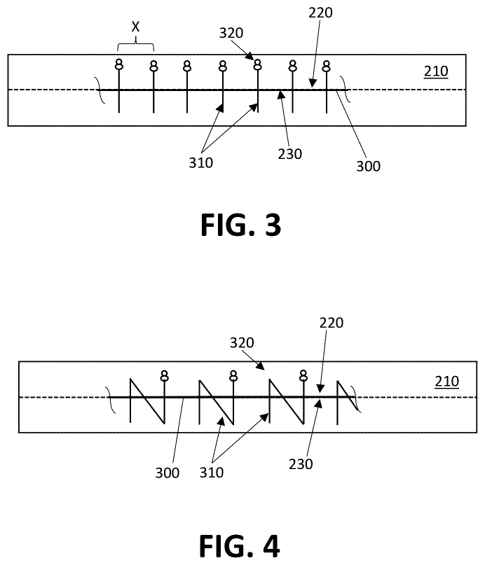

FIG. 3 is a drawing of an example pet toy in accord with at least some aspects of this disclosure representing the annular or ring-like shaped pet toy 100, 200 of FIGS. 1-2. FIG. 3 shows an example substrate 210 having a first edge 220 of the substrate 210 placed adjacent an opposing second edge 230 of the substrate 210 to form an example seam 300 wherein the first edge 220 of the substrate 210 and the second edge 230 of the substrate are joined by a plurality of interrupted or discontinuous stitches 310, joined by example knots 320 or bonding sites (e.g., adhesive bonding, thermal bonding, etc.), in the style of a single knot stitch. The example knots 320 could comprise, for example, a surgeon's knot performed by tying a double overhand throw with an additional single overhand throw placed in an opposite direction to lock the knot or a surgical slip knot permitting cinching down of the knot to tighten the stitch 310 toward the substrate to better pull the first edge 220 and the second edge 230 together, the surgical slip knot being performed by making two separate overhand knots in the same direction, then pulling taught and re-approximating the first edge 220 and the second edge 230, then placing an additional overhand throw in an opposite direction to lock the knot. The specific knot 320 type may be advantageously adapted to the particular natural or synthetic material used for the stitch 310 as different materials exhibit different coefficients of frictions or lubricity.

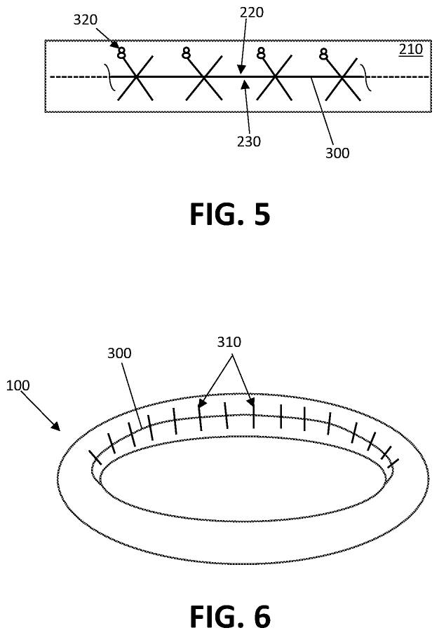

In some aspects, the example stitches 310 are disposed laterally along the example seam 300 at a regular pitch or generally regular spacing, such as a distance “X”, where X is between about 1 mm-10 mm (e.g., 1.5 mm, 2.0 mm, 2.5 mm, 3 mm, 3.5 mm, etc.), but which could also be a larger, or even a smaller, interval. In some examples, the example stitch may comprise a catch stitch, a crisscross stitch, an interrupted zig-zag stitch, or an interrupted lock stitch. An example of an interrupted zig-zag stitch is shown in FIG. 4 wherein pairs of adjacent stitches 310 are joined by a diagonal stitch. In other aspects, three adjacent stitches 310 or four adjacent stitches 310 may be connected, such as by diagonal stitching. FIG. 5 shows example crisscross stitches 310 along an example seam 320 formed by the example first edge 220 and the example second edge 230 of the substrate 210.

In some examples, the example interrupted or discontinuous stitches 310, extend away from the first edge 220 and the second edge 230 of the substrate 210 by a generally equal distance. In some examples, the example interrupted or discontinuous stitches 310, extend away from the first edge 220 and the second edge 230 of the substrate 210 by a different distance (e.g., a shorter distance from the first edge 220 than from the second edge 230, etc.) or, along at least a portion of a length of the example seam 300, the example interrupted or discontinuous stitches 310 can vary in placement and/or size relative to one or more of the adjacent example stitches 310.

The use of interrupted or discontinuous stitches 310 ensures that, should a thread used to form the stitch 310 break during use, the thread is of a sufficiently small length that it would not present any risk of harm if accidentally ingested by a pet, even where the example stitches 310 comprise nonresorbable or nonabsorbable stitches comprising one or more natural or synthetic fibers (e.g., a monofilament fiber, a polyfilament or braided fiber, etc.).

In some aspects of the present concepts, the example stitches 310 comprise resorbable or absorbable stitches comprising one or more fibers (e.g., a monofilament fiber, a polyfilament or braided fiber, etc.). In some aspects of the present concepts, the example stitches 310 comprise Fast Gut, which would break down rapidly following ingestion and lose tensile strength within about 3-5 days, or Polyglactin 910 (Irradiated) (e.g., Vicryl Rapid), which is configured to lose all tensile strength within about 5-7 days. Other materials could include, for example, gut, chromic gut, polydioxanone (e.g., PDS), or Poliglecaprone (e.g., MONOCRYL). In some aspects, the material may comprise a soluble material adapted to deteriorate in an animal's stomach, which has a pH between about 1-3, such as Nylon, which is soluble fiber in hydrochloric acid (HCl), which is the primary active component of gastric acid. In some examples, fibers may comprise cotton, viscose, or hemp, which are not acid resistant, or a polyvinyl alcohol fiber (PVA fiber) or other material that is water soluble.

In some examples, each of the example stitches 310 depicted in FIGS. 3-5 have a maximum length of less than about 3″, less than about 2″, or between about 0.25″-1″, so as to minimize a potential for the stitch to become a linear foreign body if dislodged from the pet toy and ingested.

In some aspects, where a resorbable or absorbable stitch 310 comprises a material that would degrade rapidly upon ingestion longer stitch patterns could be utilized, such as a ladder stitch or other continuous stitch over a portion of a length of the example seam 310 or an entirety of a length of the example seam 310.

In some aspects, the example seam 310 is a hidden seam (e.g., on the interior surface of the pet toy 100, 200, such as on an interior surface of the annulus or ring). When positioned on an interior surface of the pet toy 100, 200, frayed or broken stitches are disposed in a position making it more difficult for the pet to ingest the string or, for a cat in particular, for the string to get caught on the cat's tongue.

In some examples, the first substrate and/or additional substrate(s) (e.g., second substrate, third substrate) comprise a ribbon form factor having a width between about 0.5″-4″ and having a length between about 2″-8″ and, in some aspects, a ratio of length to width (L:W) of about 3:1, 4:1, 5:1 or 6:1 or any ratio therebetween.

In other embodiments of the present concepts, a pet toy may comprise a plurality of N connected substrates, where N represents any integer (e.g., 2, 3, 4, 5, etc.), such as a first substrate and a second substrate, wherein at least one seam formed at a junction of a first lateral edge of the first substrate and a first lateral edge of the second substrate are joined via one or more stitches (e.g., interrupted stitches spaced apart along the seam, a continuous stitch, etc.) formed along the seam to join the first lateral edge of the first substrate and the first lateral edge of the second substrate, wherein the one or more stitches comprise a resorbable or absorbable material, such as described above, configured to degrade if ingested by a pet. In some examples, such a pet toy may further comprise another seam formed at a junction a second lateral edge of the first substrate and a second lateral edge of the second substrate and one or more stitches formed along the another seam to join the second lateral edge of the first substrate and the second lateral edge of the second substrate. In some aspects, the first substrate and the second substrate comprise an elastomeric material, such as described above.

In other embodiments of the present concepts, a pet toy may comprise a plurality of N connected substrates, where N represents any integer (e.g., 2, 3, 4, 5, etc.), such as a first substrate and a second substrate, wherein a first seam is formed at a junction a first lateral edge of the first substrate and a first lateral edge of the second substrate and a second seam formed at a junction a second lateral edge of the first substrate and a second lateral edge of the second substrate. In this embodiment, a first plurality of interrupted stitches formed along the first seam to join the first lateral edge of the first substrate and the first lateral edge of the second substrate and a second plurality of interrupted stitches formed along the second seam to join the second lateral edge of the first substrate and the second lateral edge of the second substrate, wherein the first substrate and the second substrate comprise an elastomeric material. In some examples, each of the first plurality of interrupted stitches and the second plurality of interrupted stitches have a maximum length of less than about 3″, less than about 2″, or between about 0.25″-1″, so as to minimize a potential for the stitch to become a linear foreign body if dislodged from the pet toy and ingested. Optionally, the first plurality of interrupted stitches and the second plurality of interrupted stitches comprise a resorbable or absorbable material configured to degrade even if ingested by a pet.

In example 1, a pet toy comprises a first substrate folded to dispose a first lateral edge adjacent a second lateral edge opposite to the first lateral edge to define a seam between the first lateral edge and the second lateral edge and a plurality of stitches spaced apart along the seam in an interrupted pattern to join the first lateral edge and the second lateral edge.

In example 2, further to the pet toy according to example 1, the plurality of stitches comprise a resorbable or absorbable material configured to degrade if ingested by a pet.

In example 3, further to the pet toy according to example 1 or example 2, a material of the stitches comprises gut, Fast Gut, Irradiated Polyglactin 910, Vicryl rapid, polydioxanone or poliglecaprone.

In example 4, further to the pet toy according to any of examples 1-3, the first substrate comprises an elastomeric material.

In example 5, further to the pet toy according to any of examples 1-4, the first substrate comprises a synthetic rubber.

In example 6, further to the pet toy according to any of examples 1-5, the first substrate comprises polychloroprene or Neoprene.

In example 7, further to the pet toy according to any of examples 1-6, the first substrate comprises a laminate of a plurality of layers of one or more elastomeric materials.

In example 8, further to the pet toy according to any of examples 1-7, the first substrate comprises a second substrate, comprising a natural or a synthetic fabric or material, formed on or attached to a first side of the first substrate.

In example 9, further to the pet toy according to any of examples 1-8, the first substrate comprises a third substrate, comprising a natural or a synthetic fabric or material, formed on or attached to a second side of the first substrate.

In example 10, further to the pet toy according to any of examples 1-9, the first substrate or a plurality of substrates comprising the first substrate is formed into a generally annular or a ring-like shape or an elliptical shape.

In example 11, further to the pet toy according to any of examples 1-10, the seam is a hidden seam disposed an interior surface of generally annular or ring-like shape or elliptical shape.

In example 12, further to the pet toy according to any of examples 1-11, a diameter of the generally annular or ring-like shape, or major and minor axes of the elliptical shape, is between about 1″-4″.

In example 13, further to the pet toy according to any of examples 1-12, the plurality of stitches comprise laterally spaced apart single knot stitches.

In example 14, further to the pet toy according to any of examples 1-13, the plurality of stitches comprise a catch stitch, a crisscross stitch, an interrupted zig-zag stitch, or an interrupted lock stitch.

In example 15, a pet toy comprises a first substrate, a second substrate, a seam formed at a junction a first lateral edge of the first substrate and a first lateral edge of the second substrate, and one or more stitches formed along the seam to join the first lateral edge of the first substrate and the first lateral edge of the second substrate, wherein the one or more stitches comprise a resorbable or absorbable material configured to degrade if ingested by a pet.

In example 16, further to the pet toy according to example 15, the one or more stitches comprise interrupted stitches spaced apart along the seam.

In example 17, the pet toy according to example 15 or example 16 further comprises another seam formed at a junction a second lateral edge of the first substrate and a second lateral edge of the second substrate, and one or more stitches formed along the another seam to join the second lateral edge of the first substrate and the second lateral edge of the second substrate, wherein the first substrate and the second substrate comprise an elastomeric material.

In example 18, a pet toy comprises a first substrate, a second substrate, a first seam formed at a junction a first lateral edge of the first substrate and a first lateral edge of the second substrate, a second seam formed at a junction a second lateral edge of the first substrate and a second lateral edge of the second substrate, a first plurality of interrupted stitches formed along the first seam to join the first lateral edge of the first substrate and the first lateral edge of the second substrate, and a second plurality of interrupted stitches formed along the second seam to join the second lateral edge of the first substrate and the second lateral edge of the second substrate, wherein the first substrate and the second substrate comprise an elastomeric material.

In example 19, further to the pet toy according to example 18, each of the first plurality of interrupted stitches and the second plurality of interrupted stitches have a maximum length of less than about 3″.

In example 20, further to the pet toy according to example 18 or example 19, the first plurality of interrupted stitches and the second plurality of interrupted stitches comprise a resorbable or absorbable material configured to degrade if ingested by a pet.

What is claimed is:

1. A pet toy, comprising:
a first substrate folded to dispose a first lateral edge adjacent a second lateral edge opposite to the first lateral edge to define a seam between the first lateral edge and the second lateral edge; and
one or more stitches disposed along the seam to join the first lateral edge and the second lateral edge
wherein the one or more stitches comprise a resorbable or absorbable material configured to degrade if ingested by a pet.

2. The pet toy according to claim 1, wherein the one or more stitches comprises a plurality of stitches.

3. The pet toy according to claim 1, wherein a material of the stitches comprises gut, Fast Gut, Irradiated Polyglactin 910, Vicryl Rapid, polydioxanone or poliglecaprone.

4. The pet toy according to claim 1, wherein the first substrate comprises an elastomeric material.

5. The pet toy according to claim 1, wherein the one or more stitches comprises a continuous stitch extending along at least a portion of a length of the seam or a continuous stitch extending along an entirety of a length of the seam.

6. The pet toy according to claim 1, wherein the first substrate comprises synthetic rubber, polychloroprene or Neoprene.

7. The pet toy according to claim 1, wherein the first substrate comprises a laminate of a plurality of layers of one or more elastomeric materials.

8. The pet toy according to claim 1, wherein the first substrate comprises a second substrate, comprising a natural or a synthetic fabric or material, formed on or attached to a first side of the first substrate.

9. The pet toy according to claim 8, wherein the first substrate comprises a third substrate, comprising a natural or a synthetic fabric or material, formed on or attached to a second side of the first substrate.

10. The pet toy according to claim 1, wherein the first substrate or a plurality of substrates comprising the first substrate is formed into a generally annular or a ring-like shape or an elliptical shape.

11. The pet toy according to claim 1, wherein the seam is a hidden seam disposed an interior surface of a closed shape wherein a proximal end of the first substrate is connected to a distal end of the first substrate.

12. The pet toy according to claim 10, wherein a diameter of the generally annular or ring-like shape, or major and minor axes of the elliptical shape, is between about 1″-4″.

13. The pet toy according to claim 1, wherein the one or more stitches comprises a plurality of stitches laterally spaced apart.

14. The pet toy according to claim 13, wherein the plurality of stitches comprise a single knot stitch.

15. A pet toy, comprising:
a first substrate;
a second substrate;
a seam formed at a junction a first lateral edge of the first substrate and a first lateral edge of the second substrate; and
one or more stitches formed along the seam to join the first lateral edge of the first substrate and the first lateral edge of the second substrate,
wherein the one or more stitches comprise a resorbable or absorbable material configured to degrade if ingested by a pet.

16. The pet toy according to claim 15, wherein the one or more stitches comprises a plurality of stitches spaced apart along the seam.

17. The pet toy according to claim 15, further comprising:
another seam formed at a junction a second lateral edge of the first substrate and a second lateral edge of the second substrate; and
one or more stitches formed along the another seam to join the second lateral edge of the first substrate and the second lateral edge of the second substrate,
wherein the first substrate and the second substrate comprise an elastomeric material,
wherein the one or more stitches formed along the another seam comprise a resorbable or absorbable material configured to degrade if ingested by a pet.

18. The pet toy according to claim 17,
wherein the one or more stitches formed along the seam comprise a first plurality of stitches and the one or more stitches formed along the another seam comprise a second plurality of stitches.

19. The pet toy according to claim 18, wherein each of the first plurality of stitches and the second plurality of stitches have a maximum length of less than about 3″.

20. The pet toy according to claim 15, wherein the one or more stitches comprise gut, Fast Gut, Irradiated Polyglactin 910, Vicryl Rapid, polydioxanone or poliglecaprone.
